(19) United States
(12) Patent Application Publication
(10) Pub. No.: US 2010/0164886 A1
(43) Pub. Date: Jul. 1, 2010

(54) ELECTRONIC APPARATUS AND INPUT CONTROL METHOD

(75) Inventor: Toshikatsu NAKAMURA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/607,849

(22) Filed: Oct. 28, 2009

(30) Foreign Application Priority Data
Dec. 26, 2008 (JP) 2008-333952

(51) Int. Cl. G06F 3/041

(52) U.S. Cl. 345/173

(57) ABSTRACT

According to an embodiment, an electronic apparatus includes a first pointing device and a second pointing device, a first detection module configured to detect a first operation of the first pointing device, a second detection module configured to detect a second operation of the second pointing device, and a controller configured to execute a control procedure determined in accordance with a combination of the first operation and the second operation.

### CROSS-REFERENCE TO RELATED APPLICATIONS

This application is based upon and claims the benefit of priority from Japanese Patent Application No. 2008-333952, filed Dec. 26, 2008, the entire contents of which are incorporated herein by reference.

### BACKGROUND

1. Field

One embodiment of the invention relates to an electronic apparatus which is provided with a pointing device such as a touch pad, and also relates to an input control method.

2. Description of the Related Art

In general, in a notebook personal computer, a touch pad, which functions as a coordinate input device, is provided as a pointing device on the top surface of the housing of the main body. In usual cases, the touch pad is disposed on a substantially central part of a palm rest which is provided on the front side of a keyboard. Thereby, in the state in which the hands are placed on the palm rest in order to perform an input operation on the keyboard, an input operation can also be performed easily on the touch pad.

In the prior art, a keyboard, which is provided with two touch pads, has been thought. For instance, discloses a keyboard which is configured such that touch pads are provided at positions near a left-side end and a right-side end of the keyboard, respectively. In the case of this keyboard, for example, a cursor control function is operated by the left-side touch pad, and a scroll control function is operated by the right-side touch pad.

In this manner, in the prior art, the two touch pads are provided on the keyboard, and the cursor control function and scroll control function, which are assigned to the respective touch pads, are controlled. Specifically, the cursor control function and scroll control function are independently controlled in accordance with the individually performed operations. Accordingly, the operation on the touch pad is the same as in the case where the number of touch pads is one, and also the control, which is executed by each control function, is the same as in the case where the number of touch pads is one.

### BRIEF DESCRIPTION OF THE SEVERAL VIEWS OF THE DRAWINGS

FIG. 1 is an exemplary diagram showing a personal computer according to an embodiment;

FIG. 2 is an exemplary block diagram showing the system configuration of the personal computer according to the embodiment;

FIG. 3 is an exemplary structural diagram relating to an input control of touch pads in the personal computer according to the embodiment;

FIG. 4 is an exemplary flow chart illustrating a touch pad combinational operation setting process by a utility in the embodiment;

FIG. 5 is an exemplary diagram showing a touch pad combinational operation setting screen in the embodiment;

FIG. 6 is an exemplary flow chart illustrating a touch pad control process in the embodiment;

FIG. 7 is a diagram showing an example of operations on two touch pads in the embodiment;

FIG. 8 is a diagram showing an example of operations on the two touch pads in the embodiment;

FIG. 9 is a diagram showing an example of operations on the two touch pads in a case where a rotation function control is executed in the embodiment;

FIG. 10 is a diagram showing an example of operations on the two touch pads in a case where an enlargement/reduction function control is executed in the embodiment;

FIG. 11 is a diagram showing an example of operations on the two touch pads in a case where a sound volume/luminance function control is executed in the embodiment;

FIG. 12 is a diagram showing an example of operations on the two touch pads in a case where an audio playback function control is executed in the embodiment;

FIG. 13 is a diagram showing an example of operations in the embodiment in a case where a finger position on one touch pad is fixed and a control mode and an operation amount are designated by a finger movement direction on the other touch pad;

FIG. 14 is a diagram showing an example of operations in the embodiment in a case where a finger position on one touch pad is fixed and the control mode and operation amount are designated by a finger movement direction on the other touch pad;

FIG. 15 is an exemplary cross-sectional view showing a neighborhood region of the touch pad in the embodiment;

FIG. 16 is an exemplary cross-sectional view showing a neighborhood region of the touch pad in the embodiment;

FIG. 17 is a diagram showing the external appearance of a personal computer on which a touch pad and a mouse are provided in the embodiment;

FIG. 18 is an exemplary block diagram showing the system configuration of the personal computer in the embodiment;

FIG. 19 is an exemplary structural diagram relating to an input control of the mouse and touch pad in the personal computer of the embodiment; and

FIG. 20 is an exemplary flow chart illustrating a combinational control process of controlling the combinational operation of the touch pad and mouse in the embodiment.

### DETAILED DESCRIPTION

Various embodiments according to the invention will be described hereinafter with reference to the accompanying drawings. In general, according to one embodiment of the invention, there is provided an electronic apparatus comprising: a first pointing device and a second pointing device; a first detection module configured to detect a first operation of the first pointing device; a second detection module configured to detect a second operation of the second pointing device; and a controller configured to execute a control procedure determined in accordance with a combination of the first operation and the second operation.

An embodiment of the present invention will now be described with reference to the accompanying drawings.

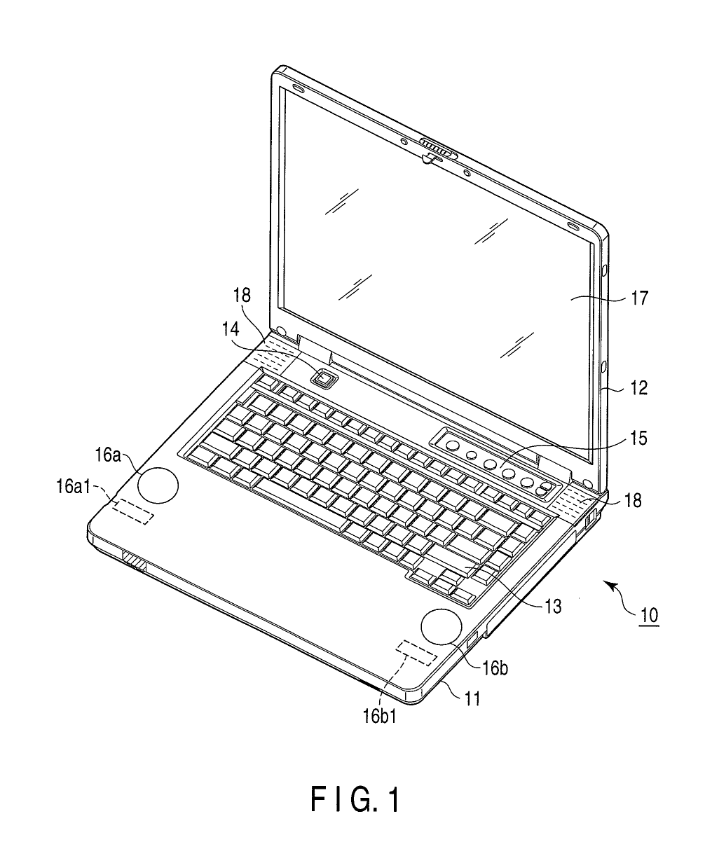

The electronic apparatus of this embodiment is realized, for example, as a notebook personal computer 10 shown in FIG. 1.

The electronic apparatus of the present invention is not limited to the personal computer 10, and may be any apparatus in which a processor for executing programs is mounted and a plurality of pointing devices, such as touch pads, can be mounted. Examples of the electronic apparatus include a mobile phone, a PDA (personal digital assistant), a portable audio/video player, a digital video camera, and a portable car navigation apparatus.

FIG. 1 is a perspective view showing the personal computer 10 in the state in which a display unit thereof is opened. The personal computer 10 is composed of a computer main body 11 and a display unit 12. A display device, which is composed of an LCD (Liquid Crystal Display) 17, is built in the display unit 12.

The display unit 12 is attached to the computer main body 11 such that the display unit 12 is rotatable between an open position where the top surface of the computer main body 11 is exposed, and a closed position where the top surface of the computer main body 11 is covered. The computer main body 11 has a thin box-shaped housing. A keyboard 13, a power button 14 for power-on/power-off, an input operation panel 15, two touch pads 16a and 16b, and speakers 18 are disposed on the top surface of the housing of the computer main body 11.

The input operation panel 15 is an input device for inputting an event corresponding to a pressed button. The input operation panel 15 includes a plurality of buttons for activating a plurality of functions.

In the personal computer 10 of the present embodiment, touch pads 16a and 16b are provided on a palm rest near left and right ends of the computer main body 11. The touch pad 16a, 16b is a pointing device which is usually touched by a user's finger tip to input coordinate data. In the example shown in FIG. 1, the touch pad 16a, 16b has a circular shape, but it may have other shapes such as a rectangular shape. In addition, in the example shown in FIG. 1, the touch pad 16a and touch pad 16b are disposed at left-and-right symmetric positions. Thereby, the same operability can be provided, regardless of whether the user is right-handed or left-handed, and the operability is enhanced when associated operations are performed at the same time on the touch pads 16a and 16b. In addition, since the touch pads 16a and 16b are provided on the left and right end sides of the computer main body 11, as shown in FIG. 1, erroneous operations on the touch pads 16a and 16b can be avoided even in the case where the hands are placed on the palm rest in order to perform an operation on the keyboard 13.

In FIG. 1, the touch pads 16a and 16b are disposed near the left and right ends of the computer main body 11. However, other arrangements of the touch pads 16a and 16b may be adopted. For example, both the touch pads 16a and 16b may be disposed in juxtaposition on a central part of the computer main body 11. Besides, one of the touch pads 16a and 16b may be disposed on an end side of the computer main body 11, and the other of the touch pads 16a and 16b may be disposed on a central side of the computer main body 11.

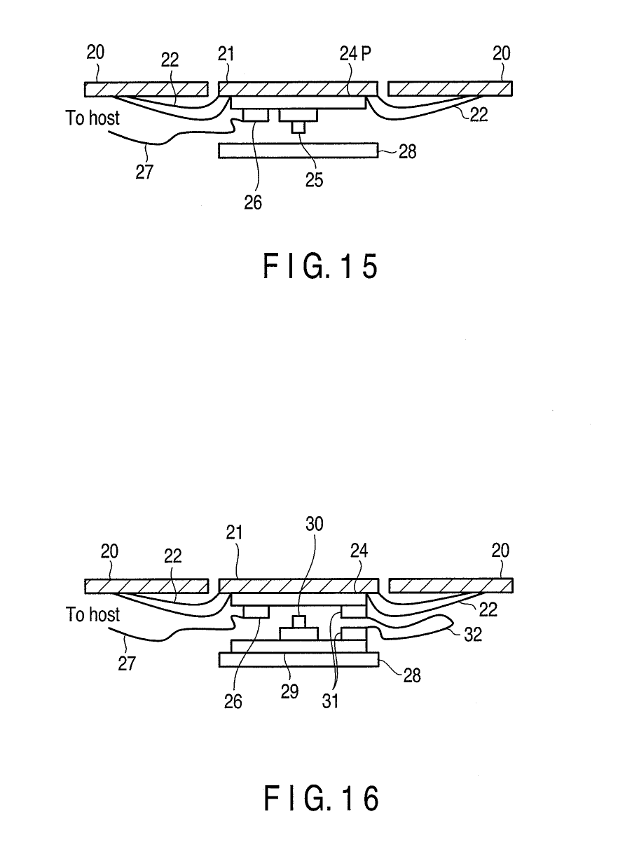

The two touch pads 16a and 16b may be provided with associated click buttons 16a1 and 16b1. In the example shown in FIG. 1, the click buttons 16a1 and 16b1 are disposed on the lower side of the associated touch pads 16a and 16b. In the meantime, in the case of adopting such a structure that button switches as shown in FIG. 15 and FIG. 16 (to be described later) are provided, the click buttons 16a1 and 16b1 are needless.

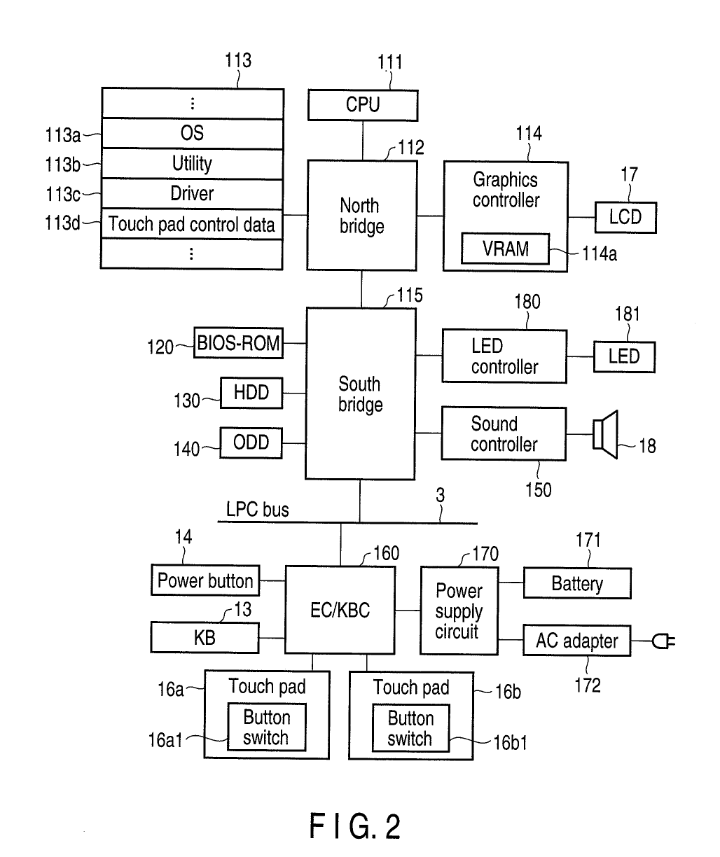

FIG. 2 is a block diagram showing the system configuration of the computer main body 11. The computer main body 11 includes a CPU 111, a north bridge 112, a main memory 113, a graphics controller 114, and a south bridge 115. The computer main body 11 further includes a BIOS-ROM 120, a hard disk drive (HDD) 130, an optical disc drive (ODD) 140, a sound controller 150, an embedded controller/keyboard controller IC (EC/KBC) 160, and a power supply circuit 170.

The CPU 111 is a processor for controlling the operation of the personal computer 10. The CPU 111 executes an operating system (OS) 113a which is loaded from a boot device, e.g. the HDD 130, into the main memory 113. In addition, the CPU 111 executes various application programs. Besides, the CPU 111 executes a system BIOS (Basic Input/Output System) that is stored in the BIOS-ROM 120. The system BIOS is a program for hardware control.

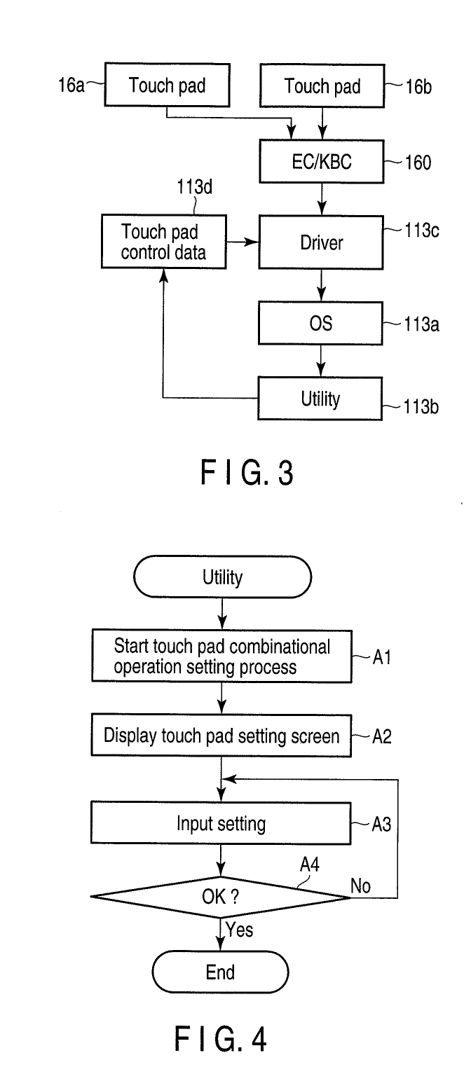

In the personal computer 10 of this embodiment, a utility 113b is prepared for setting touch pad control data 113d for input control on the touch pads 16a and 16b (the details are shown in FIG. 3 and FIG. 4). One of a plurality of control processes, which is determined in accordance with a combinational operation between an operation on the touch pad 16a and an operation on the touch pad 16b, is set in the touch pad control data 113d. The plurality of control processes include, for instance, a scroll function control, an image enlargement/reduction function control, a sound volume/luminance function control and an audio playback function control.

The driver 113c executes input control of the touch pads 16a and 16b. On the basis of a signal which is input via the EC/KBC 160, the driver 113c detects a position (coordinate data) which is pointed on the touch pad 16a, 16b. In addition, the driver 113c detects the operation (first operation, second operation) on the touch pad 16a, 16b, on the basis of the variation of the position that is pointed on the touch pad 16a, 16b. By a touch pad control process (to be described later), the driver 113c determines whether a control process, which is determined in accordance with the combinational operation (i.e. a combination of simultaneously executed operations) between an operation on the touch pad 16a and an operation on the touch pad 16b, is preset in the touch pad control data 113d. If this control process is preset, the driver 113c outputs a corresponding control code. The CPU 111 executes the control process which corresponds to the control code that is output from the driver 113c. The details will be described later.

The north bridge 112 is a bridge device that connects a local bus of the CPU 111 and the south bridge 115. The north bridge 112 includes a memory controller that access-controls the main memory 113. The north bridge 112 also has a function of executing communication with the graphics controller 114.

The graphics controller 114 is a display controller which controls the LCD 17 that is used as a display monitor of the computer 10. The graphics controller 114 includes a video memory (VRAM) 114a, and generates a video signal, which forms a display image that is to be displayed on the LCD 17, on the basis of display data that is written in the video memory 114a.

The south bridge 115 controls access to the BIOS-ROM 120. The BIOS-ROM 120 is a rewritable nonvolatile memory such as a flash ROM. As described above, the BIOS-ROM 120 stores the system BIOS. In addition, the south bridge 115 controls disc drives (I/O devices) such as the HDD 130 and ODD 140. In addition, the south bridge 115 controls various devices on an LPC bus 3.

The HDD 130 is a storage device which stores various programs and data. In the HDD 130, data write/read is executed on a magnetic disk which is rotated by a motor. The HDD 130 prestores programs such as the operating system (OS), drivers and utilities. The OS is loaded in the main memory 113 according to the system BIOS that is stored in the BIOS-ROM 120, and is executed by the CPU 111. Other programs, such as drivers and utilities, and data are loaded in the main memory 113, where necessary, and are executed by the CPU 111.

The ODD 140 is a drive unit which rotates and drives optical discs, such as a compact disc (CD) and a digital versatile disc (DVD), by means of a motor. The ODD 140 executes data read/write on optical discs.

The sound controller 150 executes control to produce sound from the speaker 18. For example, the sound controller 150 produces sound from the speaker 18 in accordance with input control (e.g. audio playback) on the touch pad 16a, 16b.

The EC/KBC 160 is a microcomputer in which an embedded controller for power management and a keyboard controller for controlling the keyboard (KB) 13 and touch pads 16a and 16b (click buttons 16a1 and 16b1) are integrated in a single chip. The EC/KBC 160 has a power control function of cooperating with the power supply circuit 170, thereby powering on the computer 10 in response to the user's operation of the power button switch 14.

The power supply circuit 170 uses DC power which is supplied from a rechargeable battery 171 or from an AC adapter 172 functioning as a high voltage power supply, thereby generating system power supply voltages which are to be applied to the respective components of the computer main body 11. The AC adapter 172 converts AC power to DC power.

FIG. 3 is a structural diagram relating to an input control of the touch pads 16 in the personal computer 10 according to the embodiment.

The EC/KBC 160 controls the input from the touch pads 16. On the basis of a signal which is input via the EC/KBC 160, the driver 113c detects coordinate data which is indicative of a position that is designated by a pointing operation on the touch pad 16. In addition, on the basis of a variation of the position that is pointed by the touch pad 16a, 16b, the driver 113c detects an operation (first operation, second operation) on the touch pad 16a, 16b. The driver 113c determines whether a control process, which corresponds to a combinational operation between the first operation and the second operation, is preset in the touch pad control data 113d. If this control process is preset, the driver 113c outputs a corresponding control code to the OS 113a.

In accordance with the control code from the driver 113c, the OS 113a executes control processes such as a scroll function control, an image enlargement/reduction function control, a sound volume/luminance function control and an audio playback function control. In addition, in the case where the setting of the input control on the touch pad 16 has been requested, the OS 113a activates the utility 113b. The utility 113b causes the LCD 17 to display a setting screen, accepts a setting request from the user, and stores the touch pad control data 113d corresponding to the setting content.

Next, the operation of the personal computer 10 in the present embodiment is described.

Referring to a flow chart of FIG. 4, a description is given of a touch pad combinational operation setting process by the utility 113b.

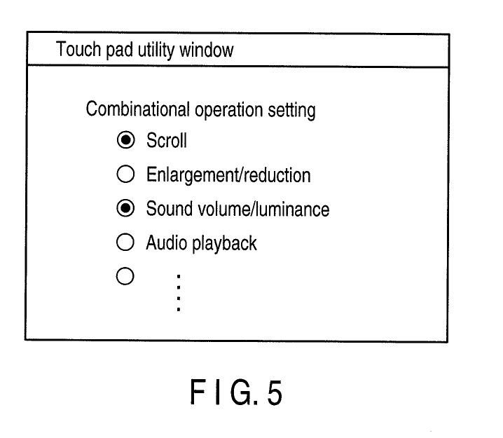

To start with, if the execution of the utility 113b is instructed by the user, the CPU 111 starts the touch pad combinational operation setting process, and causes the LCD 17 to display a touch pad setting screen (block A1, A2). FIG. 5 shows an example of the touch pad combinational operation setting screen. In the example of the touch pad combinational operation setting screen shown in FIG. 5, the screen displays a list of items representing a plurality of control processes which are determined in accordance with combinations of operations, or combinational operations, which are simultaneously executed on the touch pads 16a and 16b. The items of the displayed list are accompanied with check boxes, and a setting input by a user operation is executed in order to select check boxes (block A3). If a check box is selected by the user operation, the utility 113b displays the check box in a manner to indicate the selection of the check box. FIG. 5 shows a display example in which the items of “scroll” and “sound volume/luminance” are selected.

If the setting input by the user operation is finished (Yes in block A4), the utility 113b sets and stores the touch pad control data 113d in accordance with the item that is selected on the touch pad combinational operation setting screen. In the setting content shown in FIG. 5, the scroll function control and the sound volume/luminance function control can be executed by the combinational operations on the touch pads 16a and 16b.

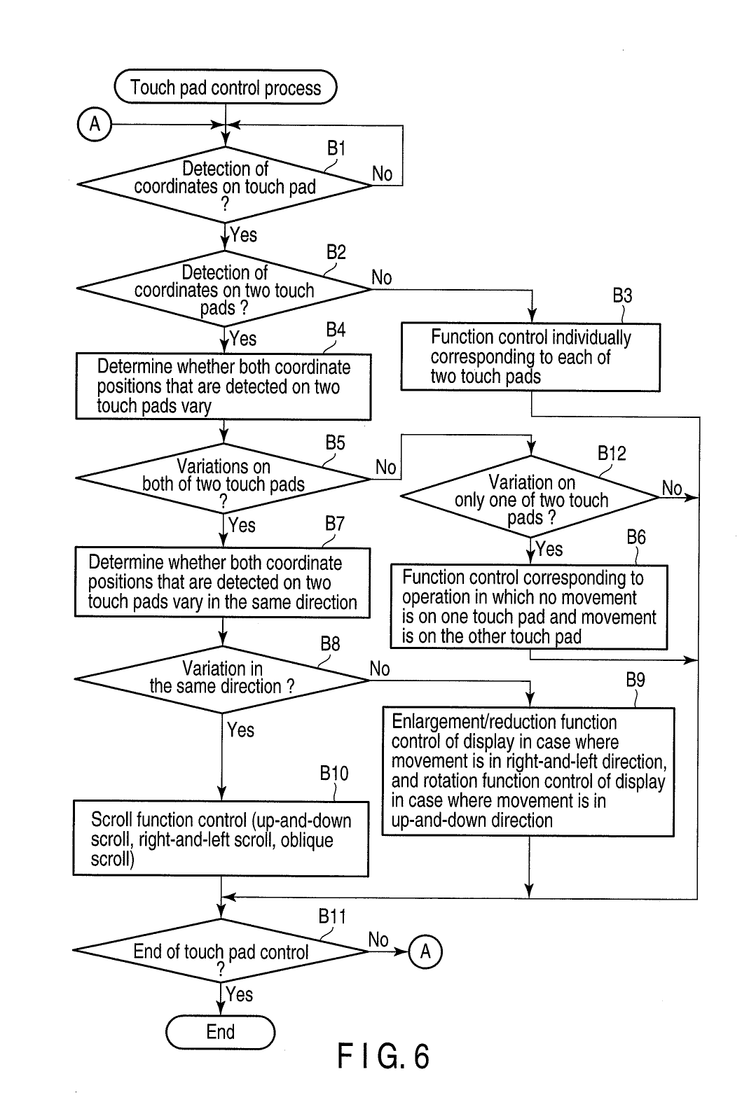

Next, referring to a flow chart of FIG. 6, a description is given of the touch pad control process in the present embodiment.

In the description below, it is assumed that the setting by the utility 113b enables the execution of the scroll function control, image enlargement/reduction function control, sound volume/luminance function control and audio playback function control.

The CPU 111 executes the touch pad control process by the driver 113c. If the coordinate data by the user's pointing operation on the touch pad 16a, 16b is detected (Yes in block B1), the CPU 111 determines whether coordinates are simultaneously detected on the two touch pads 16a and 16b. If coordinates are not simultaneously detected on the two touch pads 16a and 16b (No in block B2), that is, if coordinates are detected on one of the touch pads 16a and 16b, the CPU 111 executes a function control which individually copes with the coordinate data that is detected in each of the two touch pads 16a and 16b (block B3).

On the other hand, if coordinates are simultaneously detected on the two touch pads 16a and 16b (Yes in block B2), the CPU 111 detects, by the driver 113c, the operations (first operation, second operation) on the two touch pads 16a and 16b. If both coordinate positions, which are detected on the two touch pads 16a and 16b, vary (Yes in block B5), the CPU 111 determines whether the coordinate positions, which are detected on the two touch pads 16a and 16b, vary in the same direction (block B7).

If the coordinate positions vary in the same direction (Yes in block B8), the CPU 111 executes a scroll function control corresponding to the direction of movement of the pointing positions in the operations on the touch pads 16a and 16b (block B10).

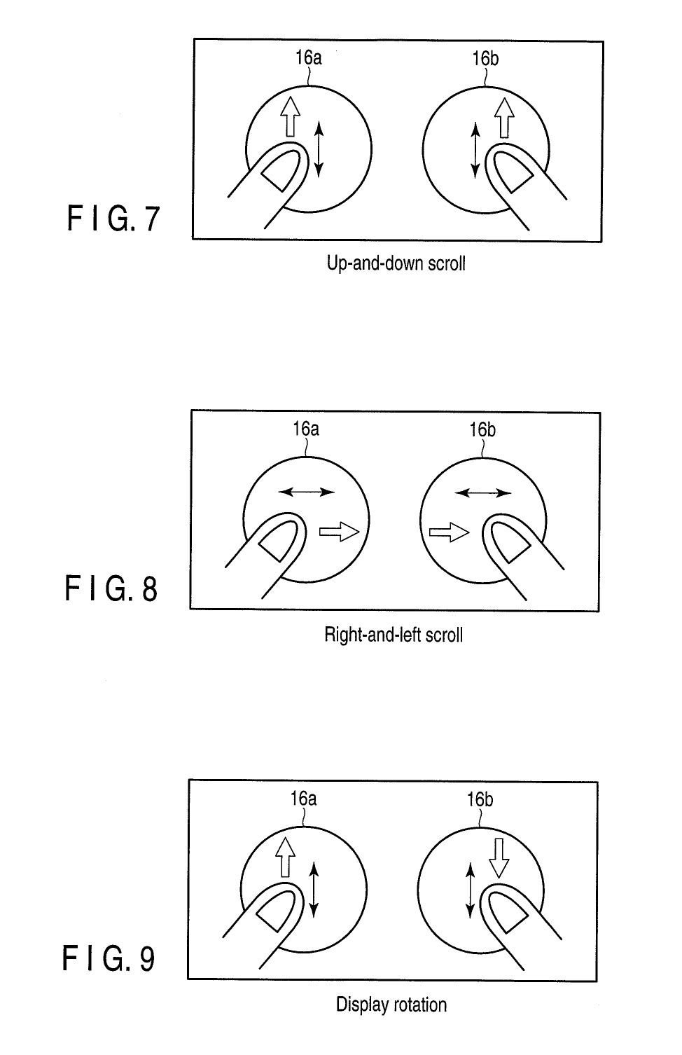

FIG. 7 and FIG. 8 show examples of operations on the touch pads 16a and 16b. As shown in FIG. 7, if the fingers are moved at the same time, for example, in the upward direction on both the touch pads 16a and 16b, the CPU 111 scrolls the screen upward. Similarly, if the fingers are moved at the same time in the downward direction, the CPU 111 scrolls the screen downward.

As shown in FIG. 8, if the fingers are moved at the same time, for example, in the rightward direction on both the touch pads 16a and 16b, the CPU 111 scrolls the screen rightward. Similarly, if the fingers are moved at the same time in the leftward direction, the CPU 111 scrolls the screen leftward.

Although not shown, if the fingers are moved in an oblique direction on both the touch pads 16a and 16b, the CPU 111 scrolls the screen in an oblique direction in accordance with the direction of movement.

On the other hand, if the coordinate positions that are detected on the touch pads 16a and 16b vary in different directions (No in block B8), the CPU 111 executes, in accordance with the direction of movement, the enlargement/reduction function control for enlarging/reducing the display content on the display screen, or the rotation function control for rotating the display content on the display screen (block B9).

FIG. 9 shows an example of the operation on the touch pads 16a and 16b in the case of executing the rotation function control. As shown in FIG. 9, if the finger is moved upward on the touch pad 16a and the finger is moved downward on the touch pad 16b, the CPU 111 executes display control to rotate the display content in the clockwise direction. On the other hand, if the finger is moved downward on the touch pad 16a and the finger is moved upward on the touch pad 16b, the CPU 111 executes display control to rotate the display content in the counterclockwise direction.

FIG. 10 shows an example of the operation on the touch pads 16a and 16b in the case of executing the enlargement/reduction function control. As shown in FIG. 10, if the finger is moved leftward on the touch pad 16a and the finger is moved rightward on the touch pad 16b, the CPU 111 executes display control to enlarge the display content. On the other hand, if the finger is moved rightward on the touch pad 16a and the finger is moved leftward on the touch pad 16b, the CPU 111 executes display control to reduce the display content.

If both coordinate positions, which are detected on the two touch pads 16a and 16b, do not vary (No in block B5), that is, if the coordinate position on one of the touch pads 16a and 16b varies (Yes in block B12), the CPU 111 executes function control corresponding to an operation in which the coordinate position detected on one of the touch pads 16a and 16b is fixed and the coordinate position detected on the other touch pad 16a, 16b varies, the function control in this case being executed in accordance with the direction of movement of the coordinate position on the other touch pad 16a, 16b (block B6). Specifically, the control mode is set by the coordinate position that is fixed and detected on one of the touch pads 16a and 16b, and the control amount is set by the direction of movement of the coordinate position detected on the other touch pad 16a, 16b. In this case, the CPU 111 executes the sound volume/luminance function control or the audio playback function control.

FIG. 11 shows an example of the operation on the touch pads 16a and 16b in the case of executing the sound volume/luminance function control. As shown in FIG. 11, in the sound volume/luminance function control, a sound volume designation area and a luminance designation area are preset on the touch pad 16a. The control mode is designated according to which of these areas includes the detected coordinate position. In the example shown in FIG. 11, a left half of the pad surface of the touch pad 16a is the sound volume designation area, and a right half of the pad surface of the touch pad 16a is the luminance designation area, and the finger is fixed on the sound volume designation area. In this state, if the finger is moved upward on the touch pad 16b, the CPU 111 executes control to increase the volume of sound which is produced from the speaker 18. On the other hand, if the finger is moved downward on the touch pad 16b, the CPU 111 executes control to decrease the volume of sound.

In the case of the state in which the finger is fixed on the luminance designation area of the touch pad 16a, if the finger is moved upward on the touch pad 16b, the CPU 111 executes control to increase the luminance of the LCD 17. On the other hand, if the finger is moved downward on the touch pad 16b, the CPU 111 executes control to decrease the luminance.

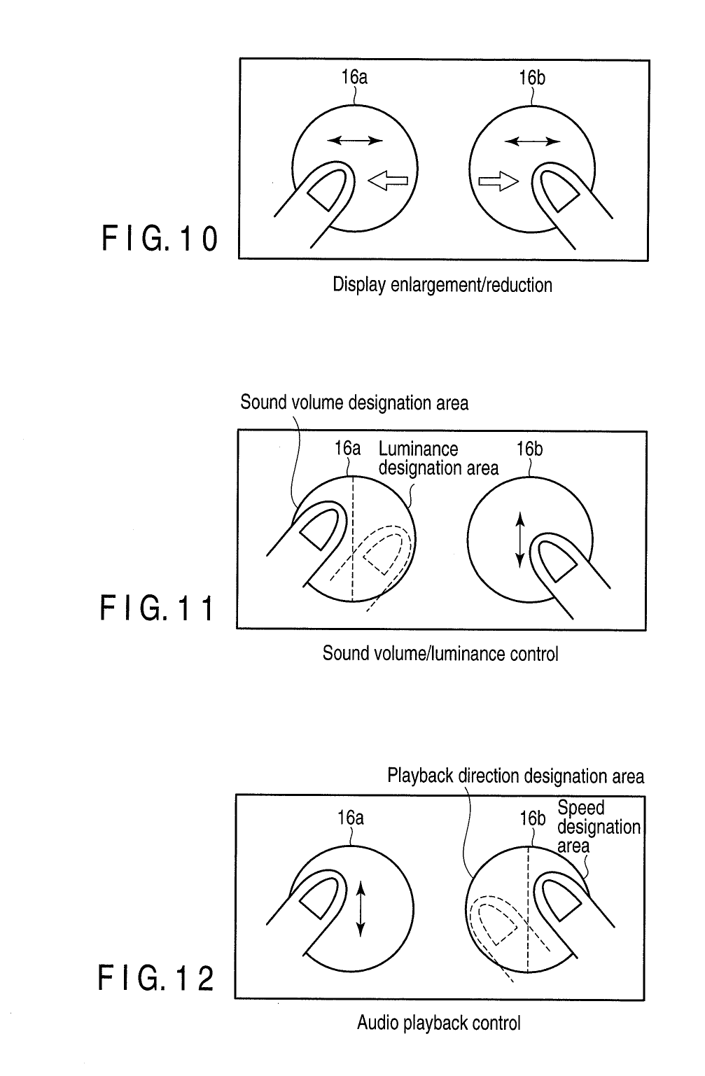

FIG. 12 shows an example of the operation on the touch pads 16a and 16b in the case of executing the audio playback function control. As shown in FIG. 12, in the audio playback function control, a playback direction designation area and a speed designation area are preset on the touch pad 16b. The control mode is designated according to which of these areas includes the detected coordinate position. In the example shown in FIG. 12, a left half of the pad surface of the touch pad 16b is the playback direction designation area, and a right half of the pad surface of the touch pad 16b is the speed designation area, and the finger is fixed on the speed designation area. In this state, if the finger is moved upward on the touch pad 16a, the CPU 111 executes control to increase the playback speed of audio which is played back and produced from the speaker 18. On the other hand, if the finger is moved downward on the touch pad 16a, the CPU 111 executes control to decrease the playback speed of audio.

In the case of the state in which the finger is fixed on the playback direction designation area of the touch pad 16b, if the finger is moved upward on the touch pad 16a, the CPU 111 executes control to set the playback direction of audio to be the forward direction. On the other hand, if the finger is moved downward on the touch pad 16a, the CPU 111 executes control to reverse the playback direction.

In FIG. 11 and FIG. 12, two areas are set on the touch pad 16a, 16b. Alternatively, three or more areas may be set.

In the examples of FIG. 11 and FIG. 12, the control mode is designated by providing a plurality of areas on the touch pad 16a, 16b. Alternatively, the control mode may be designated in accordance with the direction in which the coordinate position is varied.

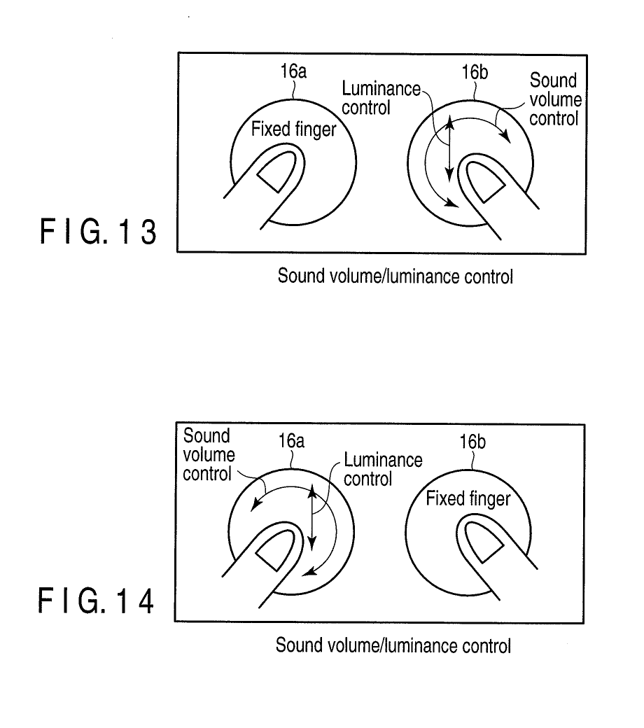

FIG. 13 shows an example of the operation in the case where the finger position on the touch pad 16a is fixed, and the control mode and the operation amount are designated by the direction of movement of the finger on the touch pad 16b. In the example shown in FIG. 13, the finger position is fixed near the center of the touch pad 16a. In this state, if the finger is moved on the touch pad 16b in the up-and-down direction, the luminance function control is designated as the control mode. In addition, the luminance is designated such that the luminance is increased by moving the finger upward and is decreased by moving the finger downward. On the other hand, in the case where the finger is moved on the touch pad 16b in a manner to describe an arc, the sound volume function control is designated as the control mode. In addition, the sound volume is designated such that the sound volume is increased by moving the finger in a manner to describe a clockwise arc, and is decreased by moving the finger in a manner to describe a counterclockwise arc.

FIG. 14 shows an example of the operation in the case where the finger position on the touch pad 16b is fixed, and the control mode and the operation amount are designated by the direction of movement of the finger on the touch pad 16a. In the example of the operation shown in FIG. 14, the operations on the touch pads 16a and 16b in FIG. 13 are interchanged, so a detailed description of the example of FIG. 14 is omitted here.

Either the use of the operation mode illustrated in FIG. 11 and FIG. 12, in which the designation areas are provided and the control mode is designated on the side on which the coordinate position is fixed, or the use of the operation mode illustrated in FIG. 13 and FIG. 14, in which the control mode is designated by the direction of movement on the side on which the coordinate position is moved, can be designated by the utility 113b along with the combinational operation setting.

As has been described above, in the personal computer 10 in the present embodiment, the function control corresponding to the combination of operations on the two touch pads 16a and 16b is executed. Therefore, novel operability, which cannot be obtained by a single pointing device, can be realized. In the case where the touch pad 16a, 16b is individually operated, the same function control as in the case of the operation by an ordinary pointing device is executed. By operating the touch pads 16a and 16b at the same time, the function control which cannot be implemented by a single pointing device can be executed. Therefore, the operable functions can be expanded, compared to the case of using a single pointing device.

The above description is directed to the case of executing operations on the touch pads 16a and 16b. Alternatively, click buttons 16a1 and 16b1, which are associated with the touch pads 16a and 16b, may be provided. The function control may be executed by combinational operations according to combinations of the operation on the click button 16a1, 16b1 and the operation on the touch pad 16a, 16b. For example, the operation on the click button 16a1, 16b1 may be combined, in place of the fixing operation on the touch pad 16a, 16b.

Besides, if the click buttons 16a1 and 16b1 are not provided, the number of parts, which constitute the personal computer 10, can be reduced, and the design can be improved. In this case, the two touch pads 16a and 16b are configured to be able to execute click operations, instead of the implementation of click operations on the click buttons 16a1 and 16b1. Specifically, the functions, which are assigned to the button operations of the click buttons 16a1 and 16b1, are assigned to tap operations of the touch pads 16a and 16b. In the structure in which a single touch pad is provided, only one function can be assigned to the tap operation on this touch pad. By contrast, with the provision of the two touch pads 16a and 16b, the tap operations on the touch pads 16a and 16b can be implemented as left/right click operations, and different functions can be assigned.

Instead of providing the click buttons 16a1 and 16b1, such a structure may be adopted that button switches are disposed on the pad surfaces of the touch pads 16a and 16b.

FIG. 15 is a cross-sectional view showing a neighborhood region of the touch pad 16a, 16b, with a button switch 25 being disposed under the pad surface of the touch pad 16a, 16b. As shown in FIG. 15, arm portions for attaching a formed part, which constitutes the touch pad 16a, 16b, to a housing 20 are composed of spring structures 22, so that the touch pad 16a, 16b may be vertically moved by pressing a pad surface 21. A pad substrate 24 is mounted on the back surface (the inner side of the housing 20) of the pad surface 21, and the button switch 25 is attached to the pad substrate 24. When the pad surface 21 is pressed, the button switch 25 comes in contact with a support plate 28 which is disposed under the pad surface 21, and thus the button switch 25 is pressed (turned on). A host connection line 27 is connected to the pad substrate 24 via a host connection connector 26, and the turn-on of the button switch 25 is reported to the CPU 111 via the host connection line 27.

FIG. 16 shows a structure example which is different from the structure shown in FIG. 15. In the structure shown in FIG. 16, like the structure of FIG. 15, the touch pad 16a, 16b is attached to the housing 20 so as to be vertically movable. In the structure shown in FIG. 16, a button switch 30 is mounted on a switch substrate 29 which is provided on the support plate 28. The pad substrate 24 and the switch substrate 29 are connected via an inter-pad-switch connection line 32 which is provided between inter-pad-switch connection connectors 31. When the touch pad 16a, 16b is pressed, the button switch 30 comes in contact with the pad substrate 24, and thus the button switch 30 is pressed (turned on). The turn-on of the button switch 30 is reported to the CPU 111 via the switch substrate 29, inter-pad-switch connection line 32, pad substrate 24 and host connection line 27.

The button switch 25, 30 is disposed, for example, at a substantially central position of the pad surface of the touch pad 16a, 16b, and an operation corresponding to a pad click can be performed together with a pointing operation on the touch pad 16a, 16b. By providing the button switch as shown in FIG. 15 or FIG. 16 on each of the touch pads 16a and 16b, the functions of the left click and right click can be assigned to the touch pads 16a and 16b. In addition, by the position (coordinates) of the finger pointing the touch pad 16a, 16b and the pressing of the button switch 25, 30, the operation of left/right click can be executed on one of the touch pads 16a and 16b. For example, in the state in which the left half area of the touch pad 16a is pointed, the pad surface is pressed and the button switch 25, 30 is pressed, and the operation in this case is set to be a left click operation. On the other hand, in the state in which the right half area of the touch pad 16a is pointed, the pad surface is pressed and the button switch 25, 30 is pressed, and the operation in this case is set to be a right click operation. Thereby, even in the structure in which one button switch 25, 30 is provided on the touch pad 16a, 16b, the left/right click operation is enabled by the operation on one of the touch pads 16a and 16b.

Next, a description is given of a structure example in which two different kinds of pointing devices are employed on the personal computer 10.

In the above-described structure, the two touch pads 16a and 16b are provided. The same control process as described above can be executed in the structure in which two kinds of pointing devices are used.

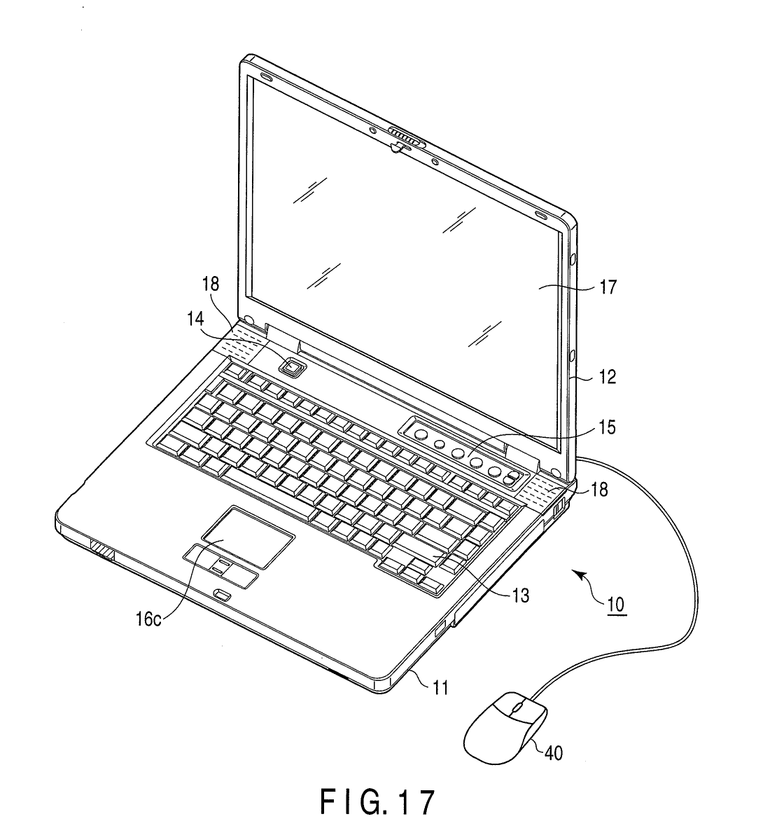

FIG. 17 shows the external appearance of a personal computer 10 which is provided with a touch pad 16c and a mouse 40 as pointing devices. In the personal computer 10 shown in FIG. 17, a single touch pad 16c is disposed at a substantially central part of the palm rest. The other structural parts are the same as shown in FIG. 1, and a description thereof is omitted.

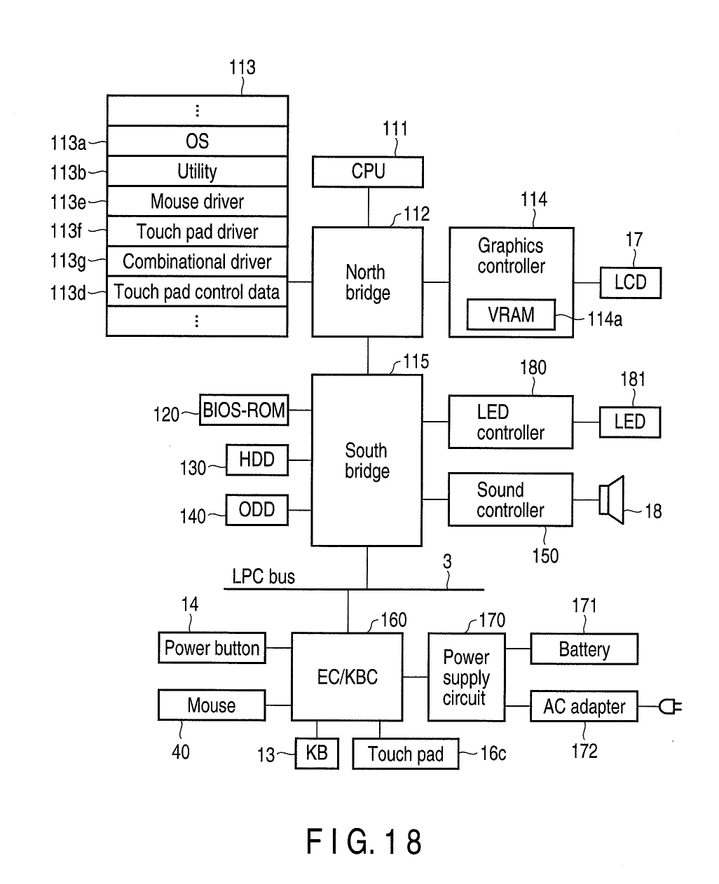

FIG. 18 is a block diagram showing the system configuration of the computer main body 11. Different parts from the configuration of FIG. 2 are described.

As shown in FIG. 18, the mouse 40, in addition to the touch pad 16c, is connected to the EC/KBC 160. The EC/KBC 160 receives a signal from the mouse 40.

The main memory 113 stores a mouse driver 113e which controls the mouse 40; a touch pad driver 113f which controls the touch pad 16c; and a combinational driver 113g which determines a combinational operation according to the combination of operations (first operation, second operation) on the mouse 40 and touch pad 16c, which are detected by the mouse driver 113e and touch pad driver 113f, and outputs a control code, which corresponds to this combinational operation, to the OS 113a.

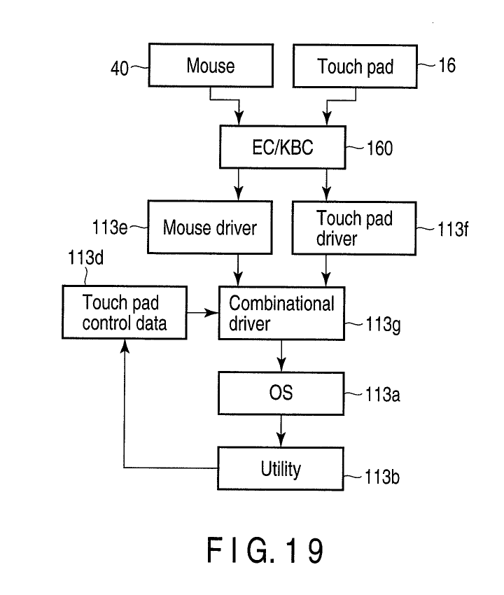

FIG. 19 is a structural diagram relating to an input control of the mouse 40 and touch pad 16 in the personal computer 10. Different parts from the structure shown in FIG. 3 are described.

The mouse driver 113e detects the operation (first operation) on the mouse 40, and the touch pad driver 113f detects the operation (second operation) on the touch pad 16c. The combinational driver 113g determines whether a control process, which corresponds to the combinational operation between the first operation that is detected by the mouse driver 113e and the second operation that is detected by the touch pad driver 113f, is preset in the touch pad control data 113d. If this control process is preset, the combinational driver 113g outputs a corresponding control code to the OS 113a.

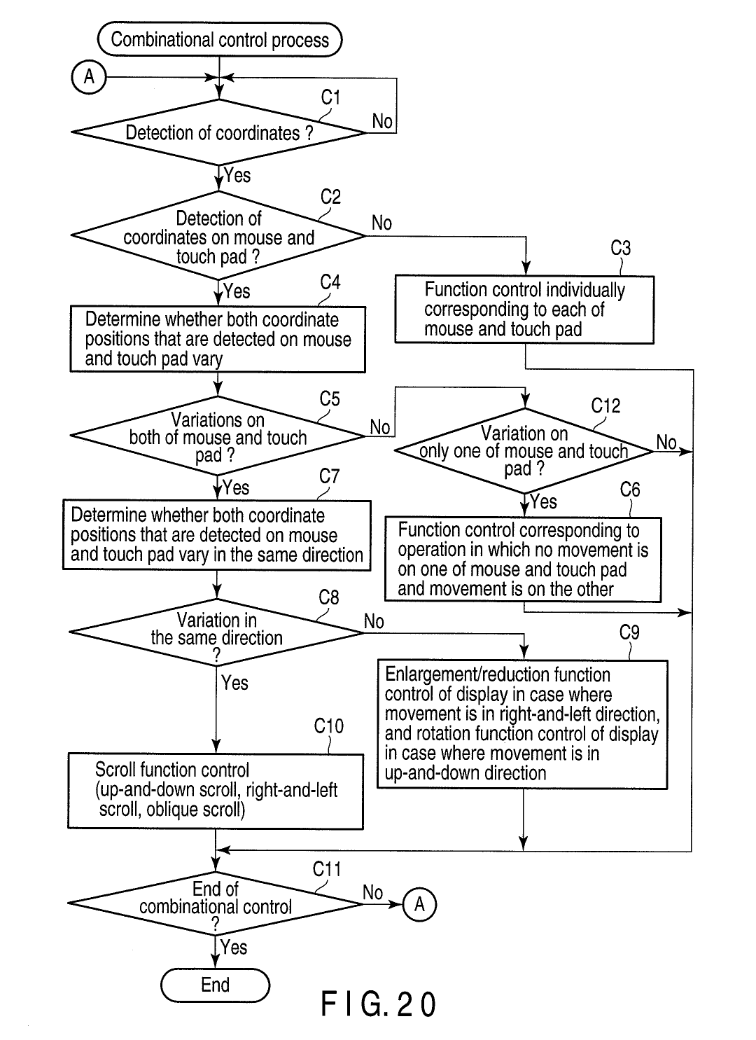

FIG. 20 is a flow chart illustrating a combinational control process which controls the combinational operation between the touch pad 16c and mouse 40. Basically the same process as the touch pad control process illustrated in FIG. 6 is executed, so a detailed description is omitted here.

In the structure in which the touch pad 16c and mouse 40 are provided, the combinational driver 113g determines the combinational operation on the basis of the combination between the operation on the touch pad 16c and the operation on the mouse 40 in the same manner as in the case of executing the function control corresponding to the combinational operation according to the combination of operations on the touch pads 16a and 16b in the touch pad control process illustrated in FIG. 6, and the combinational driver 113g executes the function control corresponding to the determination result.

Thereby, even in the structure in which different kinds of pointing devices are used, the same advantageous effects as in the above-described touch pad control can be obtained.

In the above-described structure, the mouse 40 is provided as the pointing device other than the touch pad 16c. Alternatively, aside from the mouse 40, another kind of pointing device, such as a tablet or a trackball, is usable.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first pointing device and a second pointing device;
a first detection module configured to detect a first operation of the first pointing device;
a second detection module configured to detect a second operation of the second pointing device; and
a controller configured to execute a control procedure determined in accordance with a combination of the first operation and the second operation.

2. The electronic apparatus of claim 1, further comprising a setting module configured to set one of a plurality of control procedures determined in accordance with a combination of the first operation and the second operation,
wherein the controller is configured to execute the control procedure, when there is the combination corresponding to the control procedure set by the setting module.

3. The electronic apparatus of claim 2, wherein each of the first operation and the second operation comprises an operation of moving a position which is pointed.

4. The electronic apparatus of claim 2, wherein the first operation comprises an operation of selecting one of a plurality of predetermined areas, and the second operation comprises an operation of moving a position which is pointed.

5. The electronic apparatus of claim 2, wherein the first operation comprises an operation of locking a position which is pointed, and the second operation comprises an operation of moving a position which is pointed.

6. The electronic apparatus of claim 1, wherein at least one of the first pointing device and the second pointing device comprises a touch pad.

7. The electronic apparatus of claim 1, wherein the first pointing device comprises a first touch pad, and the second pointing device comprises a second touch pad, and
the controller is configured to execute the control procedure by setting a tap operation on the first touch pad as a right click operation, and setting a tap operation on the second touch pad as a left click operation.

8. The electronic apparatus of claim 1, wherein at least one of the first pointing device and the second pointing device comprises an associated button, and
the controller is configured to execute a control procedure determined in accordance with a combination of the first operation, the second operation and an operation on the button.

9. The electronic apparatus of claim 8, wherein at least one of the first pointing device and the second pointing device comprises a touch pad, and
the button is under a pad surface of the touch pad.

10. The electronic apparatus of claim 1, wherein the first pointing device and the second pointing device are different kinds of devices, and
the electronic apparatus further comprises a determination module configured to determine the combination of the first operation and the second operation.

11. An input control method for an electronic apparatus comprising a first pointing device and a second pointing device, the method comprising:
detecting a first operation of the first pointing device and a second operation of the second pointing device; and
executing a control procedure determined in accordance with a combination of the first operation and the second operation.
